(19) United States
(12) Patent Application Publication
(10) Pub. No.: US 2025/0358765 A1
(43) Pub. Date: Nov. 20, 2025

(54) SUPPORT FOR SESSION CONTINUITY IN MULTIPLE NSACF SCENARIOS

(71) Applicant: Telefonaktiebolaget LM Ericsson (publ), Stockholm (SE)

(72) Inventor: George Foti, Dollard des Ormeaux (CA)

(21) Appl. No.: 18/872,945

(22) PCT Filed: Jun. 1, 2023
(86) PCT No.: PCT/IB2023/055657

§ 371 Date: Dec. 9, 2024

Related U.S. Application Data
(60) Provisional application No. 63/350,561, filed on Jun. 9, 2022.

(51) Int. Cl. H04W 60/04; H04W 48/02; H04W 48/18

(52) U.S. Cl. CPC H04W 60/04; H04W 48/02; H04W 48/18

(57) ABSTRACT

Systems and methods for Network Slice Admission Control (NSAC) in a cellular communications system are disclosed. In one embodiment, a method performed by a local Network Slice Admission Control Function (NSACF) comprises receiving a first request to update a number of registered User Equipments (UEs) for a network slice and sending a second request to update the number of registered UEs for the network slice to a central NSACF in response to determining that a maximum number of registered UEs for the network slice is reached. The method further comprises receiving a response from the central NSACF and operating accordingly, wherein the response indicates whether admission of the particular UE to the network slice is accepted or rejected and comprises an instruction defining a threshold to be applied by the local NSACF for future requests to update the number of registered UEs for the network slice for new UE registrations.

### RELATED APPLICATIONS

This application claims the benefit of provisional patent application Ser. No. 63/350,561, filed Jun. 9, 2022, the disclosure of which is hereby incorporated herein by reference in its entirety.

### TECHNICAL FIELD

The present disclosure relates to a cellular communication system and, more specifically, to network slice admission control in a cellular communications system and enables session continuity.

### BACKGROUND

In the Third Generating Partnership Project (3GPP) Fifth Generation System (5GS), network slicing is a network architecture in which multiple logical networks are virtualized on the same physical network infrastructure. Each network slice may support one or more services (e.g., an enhanced Mobile Broadband (eMBB) service, an Ultra-Reliable Low-Latency Communication (URLLC) service, etc.), each having its own service-level requirements.

Network Slice Admission Control (NSAC) is defined in Third Generation Partnership Project (3GPP) Technical Specification (TS) 23.501 (see, e.g., V17.3.0) chapter 5.15.11, and Network Slice Admission Control Function (NSACF) procedures are defined in 3GPP TS 23.502 (see, e.g., V17.3.0) chapter 4.2.11. In general, NSAC is used to control the number of registered User Equipments (UEs) or the number of Protocol Data Unit (PDU) sessions per network slice. The NSACF is the Network Function (NF) that performs NSAC.

A description of network slicing is available in 3GPP TS 23.501, and the Fifth Generation System (5GS) procedures are defined in 3GPP TS 23.502.

### SUMMARY

Systems and methods for Network Slice Admission Control (NSAC) in a cellular communications system are disclosed. In one embodiment, a method comprises, at a local Network Slice Admission Control Function (NSACF), receiving from a network function a first request to update a number of registered User Equipments (UEs) for a network slice in association with a registration request for a particular UE for the network slice and sending a second request to update the number of registered UEs for the network slice to a central NSACF in response to determining that a maximum number of registered UEs for the network slice is reached. The method further comprises, at the central NSACF, receiving the second request from the local NSACF and sending a response to the local NSACF, wherein the response indicates that admission of the particular UE to the network slice is either accepted or rejected and the response comprises an instruction defining a threshold to be applied by the local NSACF for future requests to update the number of registered UEs for the network slice for new UE registrations to the network slice. The method further comprises, at the local NSACF, receiving the response from the central NSACF, rejecting or accepting admission of the particular UE for the particular network slice in accordance with the response received from the central NSACF, and applying the instruction from the central NSACF when determining whether the local NSACF can admit new UE registrations to the network slice in future requests to update the number of registered UEs for the network slice at the local NSACF. In this manner, a flexible framework for supporting session continuity when applying NSAC is provided.

In one embodiment, the first request or the second request include an indication that the registration request is related to a mobility event of the UE moving from an old service area.

In one embodiment, the method further comprises, at the central NSACF, keeping a sufficient reserve of quota for handling admission of UEs moving between service areas.

In one embodiment, the particular UE is a UE for which the registration request is a new registration request, and the response from the central NSACF to the local NSACF indicates that admission of the particular UE to the network slice is rejected.

In one embodiment, the particular UE is a UE for which the registration request is made in association with a mobility event for the particular UE, and the response from the central NSACF to the local NSACF indicates that admission of the particular UE to the network slice is accepted.

In one embodiment, the threshold defined by the instructions is an adjusted maximum number of registered UEs for the network slice that can be admitted by the local NSACF. In one embodiment, the instruction comprises an instruction to not admit new UE registrations until the number of registered UEs for the network slice at the local NSACF is less than a defined percentage of the threshold.

In one embodiment, a method performed by a local NSACF comprise receiving from a network function a first request to update a number of registered UEs for a network slice in association with a registration request for a particular UE for the network slice and sending a second request to update the number of registered UEs for the network slice to a central NSACF in response to determining that a maximum number of registered UEs for the network slice is reached. The method further comprises receiving a response from the central NSACF, wherein the response indicates that admission of the particular UE to the network slice is either accepted or rejected and the response comprises an instruction defining a threshold to be applied by the local NSACF for future requests to update the number of registered UEs for the network slice for new UE registrations to the network slice. The method further comprises rejecting or accepting admission of the particular UE for the particular network slice in accordance with the response received from the central NSACF and applying the instruction from the central NSACF when determining whether the local NSACF can admit new UE registrations to the network slice in future requests to update the number of registered UEs for the network slice at the local NSACF.

In one embodiment, the first request or the second request include an indication that the registration request is related to a mobility event of the UE moving from an old service area.

In one embodiment, the particular UE is a UE for which the registration request is a new registration request, and the response from the central NSACF indicates that admission of the particular UE to the network slice is rejected.

In one embodiment, the particular UE is a UE for which the registration request is made in association with a mobility event for the particular UE, and the response from the central NSACF indicates that admission of the particular UE to the network slice is accepted.

In one embodiment, the threshold defined by the instructions is an adjusted maximum number of registered UEs for the network slice that can be admitted by the local NSACF. In one embodiment, the instruction comprises an instruction to not admit new UE registrations until the number of registered UEs for the network slice at the local NSACF is less than a defined percentage of the threshold.

Corresponding embodiments of a network node are also disclosed. In one embodiment, a network node for implementing a local NSACF comprises processing circuitry configured to cause the network node to receive from a network function a first request to update a number of registered UEs for a network slice in association with a registration request for a particular UE for the network slice and send a second request to update the number of registered UEs for the network slice to a central NSACF in response to determining that a maximum number of registered UEs for the network slice is reached. The processing circuitry is further configured to cause the network node to receive a response from the central NSACF, wherein the response indicates that admission of the particular UE to the network slice is either accepted or rejected and the response comprises an instruction defining a threshold to be applied by the local NSACF for future requests to update the number of registered UEs for the network slice for new UE registrations to the network slice. The processing circuitry is further configured to cause the network node to reject or accept admission of the particular UE for the particular network slice in accordance with the response received from the central NSACF and apply the instruction from the central NSACF when determining whether the local NSACF can admit new UE registrations to the network slice in future requests to update the number of registered UEs for the network slice at the local NSACF.

In one embodiment, a method performed by a central NSACF comprises receiving, from a local NSACF, a request to update the number of registered UEs for a network slice and sending a response to the local NSACF, wherein the response indicates that admission of the particular UE to the network slice is either accepted or rejected and the response comprises an instruction defining a threshold to be applied by the local NSACF for future requests to update the number of registered UEs for the network slice for new UE registrations to the network slice.

In one embodiment, the request includes an indication that the registration request is related to a mobility event of the UE moving from an old service area.

In one embodiment, the method further comprises keeping a sufficient reserve of quota for handling admission of UEs moving between service areas.

In one embodiment, the particular UE is a UE for which the registration request is a new registration request, and the response sent from the central NSACF to the local NSACF indicates that admission of the particular UE to the network slice is rejected.

In one embodiment, the particular UE is a UE for which the registration request is made in association with a mobility event for the particular UE, and the response sent from the central NSACF to the local NSACF indicates that admission of the particular UE to the network slice is accepted.

In one embodiment, the threshold defined by the instructions is an adjusted maximum number of registered UEs for the network slice that can be admitted by the local NSACF. In one embodiment, the instruction comprises an instruction to not admit new UE registrations until the number of registered UEs for the network slice at the local NSACF is less than a defined percentage of the threshold.

Corresponding embodiments of a network node for implementing a central NSACF are also disclosed. In one embodiment, a network node for implementing a central NSACF comprises processing circuitry configured to cause the network node to receive, from a local NSACF, a request to update the number of registered UEs for a network slice and send a response to the local NSACF, wherein the response indicates that admission of the particular UE to the network slice is either accepted or rejected and the response comprises an instruction defining a threshold to be applied by the local NSACF for future requests to update the number of registered UEs for the network slice for new UE registrations to the network slice.

In one embodiment, a method comprises, at a local NSACF, receiving from a network function a first request to update a number of Protocol Data Unit (PDU) sessions for a network slice in association with a PDU session establishment request for a particular UE for the network slice and sending a second request to update the number of PDU sessions for the network slice to a central NSACF responsive to determining that a maximum number of PDU sessions for the network slice is reached. The method further comprises, at the central NSACF, receiving the second request from the local NSACF and sending a response to the local NSACF, wherein the response indicates that admission of a PDU session to the network slice is either accepted or rejected and the response comprises an instruction defining a threshold to be applied by the local NSACF for future requests to update the number of PDU sessions for the network slice for PDU session establishment request from newly registered UEs to the network slice. The method further comprises, at the local NSACF, receiving the response from the central NSACF, rejecting or accepting admission of a PDU session for the particular UE for the particular network slice in accordance with the response received from the central NSACF and applying the instruction from the central NSACF when determining whether the local NSACF can admit future requests to update the number of PDU sessions for the network slice at the local NSACF received in association with respective PDU session establishment requests for the network slice made from newly registered UEs to the network slice.

In one embodiment, the first request or the second request include an indication that the registration request is related to a mobility event of the UE moving from an old service area.

In one embodiment, the method further comprises, at the central NSACF, keeping a sufficient reserve of quota for handling admission of UEs moving between service areas.

In one embodiment, the particular UE is a newly registered UE for which the PDU session establishment request is not associated with a mobility event, and the response from the central NSACF to the local NSACF indicates that admission of a PDU session for the particular UE to the network slice is rejected.

In one embodiment, the particular UE is a UE for which the PDU session establishment request is made in association with a mobility event for the particular UE, and the response from the central NSACF to the local NSACF indicates that admission of a PDU session for the particular UE to the network slice is accepted.

In one embodiment, the threshold defined by the instructions is an adjusted maximum number of PDU sessions for the network slice that can be admitted by the local NSACF. In one embodiment, the instruction comprises an instruction to not admit PDU sessions for which respective PDU session establishment requests are not associated with a mobility event until the number of PDU sessions for the network slice at the local NSACF is less than a defined percentage of the threshold.

In one embodiment, a method performed by a local NSACF comprises receiving (806) from a network function a first request to update a number of Protocol Data Unit, PDU, sessions for a network slice in association with a PDU session establishment request for a particular UE for the network slice and sending a second request to update the number of PDU sessions for the network slice to a central NSACF responsive to determining that a maximum number of PDU sessions for the network slice is reached. The method further comprises receiving a response from the central NSACF, wherein the response indicates that admission of a PDU session to the network slice is either accepted or rejected and the response comprises an instruction defining a threshold to be applied by the local NSACF for future requests to update the number of PDU sessions for the network slice for PDU session establishment requests from newly registered UEs to the network slice. The method further comprises rejecting or accepting admission of a PDU session for the particular UE for the particular network slice in accordance with the response received from the central NSACF and applying the instruction from the central NSACF when determining whether the local NSACF can admit future requests to update the number of PDU sessions for the network slice at the local NSACF (314) received in association with respective PDU session establishment requests for the network slice made by respective newly registered UEs to the network slice.

In one embodiment, the first request or the second request include an indication that the registration request is related to a mobility event of the UE moving from an old service area.

In one embodiment, the particular UE is a newly registered UE for which the PDU session establishment request is not associated with a mobility event, and the response from the central NSACF indicates that admission of a PDU session for the particular UE to the network slice is rejected.

In one embodiment, the particular UE is a UE for which the PDU session establishment request is made in association with a mobility event for the particular UE, and the response from the central NSACF indicates that admission of a PDU session for the particular UE to the network slice is accepted.

In one embodiment, the threshold defined by the instructions is an adjusted maximum number of PDU sessions for the network slice that can be admitted by the local NSACF. In one embodiment, the instruction comprises an instruction to not admit PDU sessions for which respective PDU session establishment requests are from newly registered UEs until the number of PDU sessions for the network slice at the local NSACF (314) is less than a defined percentage of the threshold.

Corresponding embodiments of a network node for implementing a local NSACF are also disclosed. In one embodiment, a network node for implementing a local NSACF comprises processing circuitry configured to cause the network node to receive from a network function a first request to update a number of PDU sessions for a network slice in association with a PDU session establishment request for a particular UE for the network slice and send a second request to update the number of PDU sessions for the network slice to a central NSACF responsive to determining that a maximum number of PDU sessions for the network slice is reached. The processing circuitry is further configured to cause the network node to receive a response from the central NSACF, wherein the response indicates that admission of a PDU session to the network slice is either accepted or rejected and the response comprises an instruction defining a threshold to be applied by the local NSACF for future requests to update the number of PDU sessions for the network slice for PDU session establishment request from newly registered UEs to the network slice. The processing circuitry is further configured to cause the network node to reject or accept admission of a PDU session for the particular UE for the particular network slice in accordance with the response received from the central NSACF and apply the instruction from the central NSACF when determining whether the local NSACF can admit future requests to update the number of PDU sessions for the network slice at the local NSACF received in association with respective PDU session establishment requests for the network slice made by respective newly registered UEs to the network slice.

In one embodiment, a method performed by a central NSACF comprises receiving, from a local NSACF, a request to update a number of PDU sessions for a network slice and sending a response to the local NSACF, wherein the response indicates that admission of a PDU session to the network slice is either accepted or rejected and the response comprises an instruction defining a threshold to be applied by the local NSACF for future requests to update the number of PDU sessions for the network slice for PDU session establishment request from newly registered UEs to the network slice.

In one embodiment, the request includes an indication that the PDU session establishment request is related to a mobility event of the UE moving from an old service area.

In one embodiment, the method further comprises keeping a sufficient reserve of quota for handling admission of PDU sessions for UEs moving between service areas.

In one embodiment, the particular UE is a newly registered UE for which the PDU session establishment request is not associated with a mobility event, and the response sent from the central NSACF to the local NSACF indicates that admission of a PDU session for the particular UE to the network slice is rejected.

In one embodiment, the particular UE is a UE for which the PDU session establishment request is made in association with a mobility event for the particular UE, and the response sent from the central NSACF to the local NSACF indicates that admission of a PDU session for the particular UE to the network slice is accepted.

In one embodiment, the threshold defined by the instructions is an adjusted maximum number of PDU sessions for the network slice that can be admitted by the local NSACF. In one embodiment, the instruction comprises an instruction to not admit PDU sessions for which respective PDU session establishment requests are from newly registered UEs until the number of PDU sessions for the network slice at the local NSACF is less than a defined percentage of the threshold.

Corresponding embodiments of a network node for implementing a central NSACF are also disclosed. In one embodiment, a network node for implementing a central NSACF comprises processing circuitry configured to cause the network node to receive, from a local NSACF, a request to update a number of PDU sessions for a network slice and send a response to the local NSACF, wherein the response indicates that admission of a PDU session to the network slice is either accepted or rejected and the response comprises an instruction defining a threshold to be applied by the local NSACF for future requests to update the number of PDU sessions for the network slice for PDU session establishment request from newly registered UEs to the network slice.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system according to some embodiments of the present disclosure;

FIGS. 2, 3, and 4 illustrate example embodiments in which the cellular communication system of FIG. 1 is a Fifth Generation (5G) System (5GS);

FIG. 5 illustrates aspects of example embodiments of the present disclosure;

FIGS. 6A and 6B illustrate a procedure in accordance with one example embodiment of the present disclosure;

FIG. 7 illustrates a procedure in accordance with another example embodiment of the present disclosure;

FIGS. 8A and 8B illustrate a procedure in accordance with another example embodiment of the present disclosure; and

FIGS. 9, 10, and 11 are schematic block diagrams of example embodiments of a network node.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). There is a need to fulfill the following requirement when there is interworking between the Third Generation Partnership Project (3GPP) Evolved Packet Core (EPC) and the 3GPP Fifth Generation Core (5GC) for network slice(s) that are subject to Network Slice Admission Control (NSAC). During mobility between EPC and 5GC, more specifically while roaming, multiple Network Slice Admission Control Functions (NSACFs) are used since the Evolved Packet System (EPS) is home routed while the Access and Mobility management Function (AMF) in the 5GC is in the visited domain. In this case, there is need to support the following:
When a User Equipment (UE) moves to 5GC from EPC, NSACF in 5GC will have to admit the UE if it is coming in from EPC even if the NSACF in 5GC has depleted all its quota.

In addition to the above, there is a need to ensure session continuity when there is inter-mobility between AMFs in Fifth Generation (5G) for network slices that are requested or allowed in the old AMF and supported, requested, and allowed in the new AMF and that are subject to NSAC when the new AMF is in a new service area served by a different NSACF than the old AMF. Hence, in this case, the NSACF used by the new AMF will have to admit the UE if it is coming in from an old service area even if the NSACF has depleted all its quota.

Certain aspects of the present disclosure and their embodiments may provide solutions to the aforementioned or other challenges. The existing solution cannot guarantee session interworking in all cases and is not foolproof.

Systems and methods related to NSAC in a cellular communications system are disclosed. In one embodiment, a method comprises, at a local NSACF, receiving a request to update a number of registered UEs for a network slice in association with a registration request for a particular UE for the network slice, determining that the local NSACF cannot admit the particular UE for the network slice, and, responsive to determining that the local NSACF cannot admit the particular UE for the network slice, sending a request to update the number of registered UEs for the network slice to a central NSACF. The method further comprises, at the central NSACF, receiving the request from the local NSACF and sending a response to the local NSACF, wherein the response indicates that admission of the particular UE to the network slice is either accepted or rejected, and the response comprises instructions about handling of future requests to update the number of registered UEs for the network slice at the local NSACF received in association with registration requests for the network slice made by UEs for which the registration requests are new registration requests. The method further comprises, at the local NSACF, receiving the response from the central NSACF, rejecting or accepting admission of the particular UE for the particular network slice in accordance with the response received from the central NSACF, and applying the instructions comprised in the response when determining whether the local NSACF can admit future requests to update the number of registered UEs for the network slice at the local NSACF received in association with respective registration requests for the network slice made by respective UEs for which the registration requests are new registration requests.

In one embodiment, the particular UE is a UE for which the registration request is a new registration request, and the response from the central NSACF to the local NSACF indicates that admission of the particular UE to the network slice is rejected.

In one embodiment, the particular UE is a UE for which the registration request is made in association with a mobility event for the particular UE, and the response from the central NSACF to the local NSACF indicates that admission of the particular UE to the network slice is accepted.

In one embodiment, the instructions comprise an instruction to not admit UEs for which respective registration requests are new registration requests until the number of registered UEs for the network slice at the local NSACF is less than a threshold. In one embodiment, the threshold is a percentage of the defined maximum number of registered UEs for the network slice that can be admitted by the local NSACF. In one embodiment, the instructions further comprise an instruction to change the defined maximum number of registered UEs for the network slice that can be admitted by the local NSACF, and the threshold is a percentage of the changed maximum number of registered UEs for the network slice that can be admitted by the local NSACF.

In another embodiment, a method comprises, at a local NSACF, receiving a request to update a number of Protocol Data Unit (PDU) sessions for a network slice in association with a PDU session establishment request for a particular UE for the network slice, determining that the local NSACF cannot admit a PDU session for the network slice, and, responsive to determining that the local NSACF cannot admit a PDU session for the network slice, sending a request to update the number of PDU sessions for the network slice to a central NSACF. The method further comprises, at the central NSACF, receiving the request from the local NSACF and sending a response to the local NSACF, wherein the response indicates that admission of a PDU session to the network slice is either accepted or rejected and the response comprises instructions about handling of future requests to update the number of PDU sessions for the network slice at the local NSACF received in association with PDU session establishment requests for the network slice made by UEs for which the PDU session establishment requests are not associated with a mobility event. The method further comprises, at the local NSACF, receiving the response from the central NSACF, rejecting or accepting admission of a PDU session for the particular UE for the particular network slice in accordance with the response received from the central NSACF, and applying the instructions comprised in the response when determining whether the local NSACF can admit future requests to update the number of PDU sessions for the network slice at the local NSACF received in association with respective PDU session establishment requests for the network slice made by respective UEs for which the PDU session establishment requests are not associated with a mobility event.

Embodiments of a local NSACF, a central NSACF, and methods of operation thereof are also disclosed herein.

Certain embodiments may provide one or more of the following technical advantage(s). Embodiments of the present disclosure define clear roles for the local and central NSACF. Embodiments of the present disclosure provide a single point of control in the central NSACF with a flexible framework, supporting fine granularity for providing interactions to the local NSACF. Embodiments of the present disclosure provide a foolproof flexible framework for supporting session continuity.

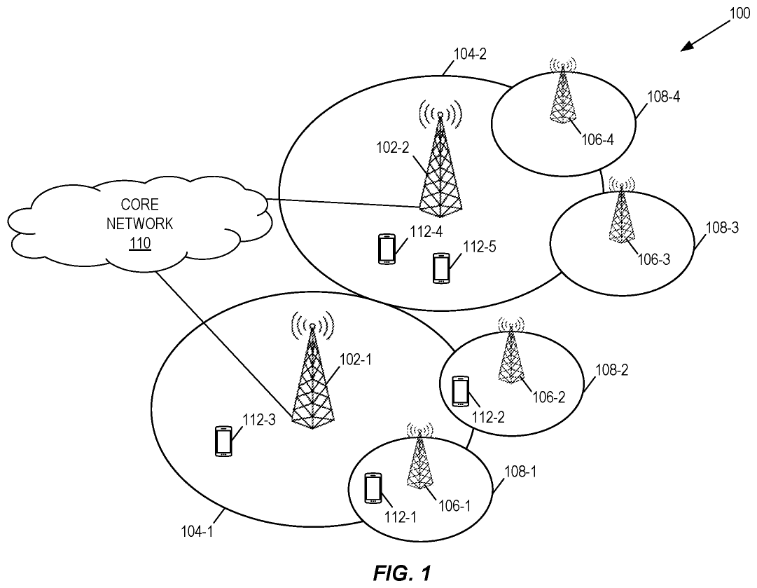

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC); however, the present disclosure is not limited thereto. In this example, the RAN includes base stations 102-1 and 102-2, which in the 5GS include NR base stations (gNBs) and optionally next generation eNBs (ng-eNBs), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or RRHs, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

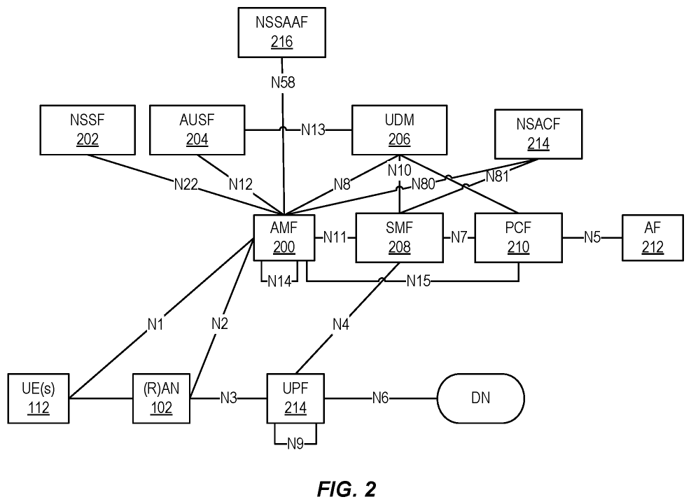

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the system 100 of FIG. 1.

Seen from the access side the 5G network architecture shown in FIG. 2 comprises a plurality of UEs 112 connected to either a RAN 102 or an Access Network (AN) as well as an AMF 200. Typically, the R (AN) 102 comprises base stations, e.g. such as eNBs or gNBs or similar. Seen from the core network side, the 5GC NFs shown in FIG. 2 include a NSSF 202, an AUSF 204, a UDM 206, the AMF 200, a SMF 208, a PCF 210, an Application Function (AF) 212, a Network Slice Admission Control Function (NSACF) 214, and a Network Slice-specific and Stand-alone Non-Public Network (SNPN) Authentication and Authorization Function (NSSAAF) 216.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208.

The 5GC network aims at separating UP and CP. The UP carries user traffic while the CP carries signaling in the network. In FIG. 2, the UPF 214 is in the UP and all other NFs, i.e., the AMF 200, SMF 208, PCF 210, AF 212, NSSF 202, AUSF 204, and UDM 206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated as shown in FIG. 2. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

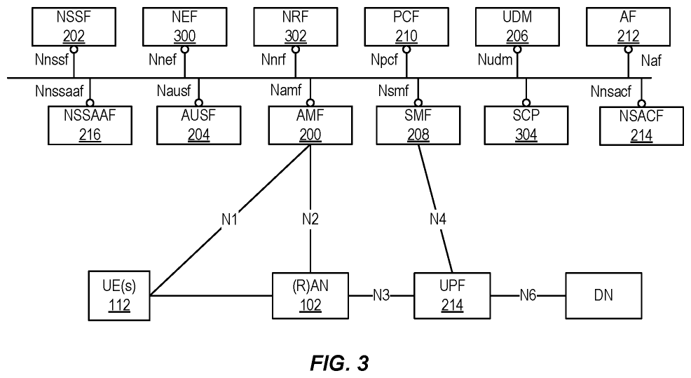

FIG. 3 illustrates a 5G network architecture using service-based interfaces between the NFs in the CP, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g. Namf for the service based interface of the AMF 200 and Nsmf for the service based interface of the SMF 208, etc. The NEF 300, the NRF 302, and a Service Communication Proxy (SCP) 304 in FIG. 3 are not shown in FIG. 2 discussed above. However, it should be clarified that all NFs depicted in FIG. 2 can interact with the NEF 300 and the NRF 302 of FIG. 3 as necessary, though not explicitly indicated in FIG. 2.

Some properties of the NFs shown in FIGS. 2 and 3 may be described in the following manner. The AMF 200 provides UE-based authentication, authorization, mobility management, etc. A UE 112 even using multiple access technologies is basically connected to a single AMF 200 because the AMF 200 is independent of the access technologies. The SMF 208 is responsible for session management and allocates Internet Protocol (IP) addresses to UEs. It also selects and controls the UPF 214 for data transfer. If a UE 112 has multiple sessions, different SMFs 208 may be allocated to each session to manage them individually and possibly provide different functionalities per session. The AF 212 provides information on the packet flow to the PCF 210 responsible for policy control in order to support QoS. Based on the information, the PCF 210 determines policies about mobility and session management to make the AMF 200 and SMF 208 operate properly. The AUSF 204 supports authentication function for UEs or similar and thus stores data for authentication of UEs or similar while the UDM 206 stores subscription data of the UE 112. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

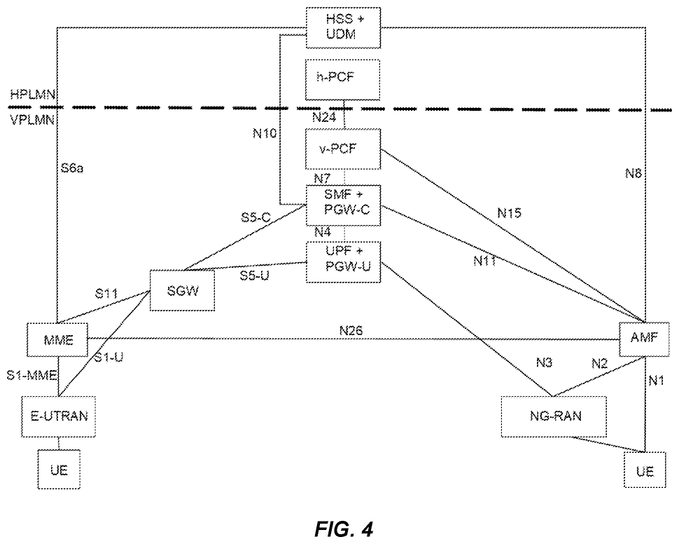

FIG. 4 illustrates the local breakout roaming architecture for interworking between 5GS and EPC/E-UTRAN as defined in 3GPP TS 23.501.

### 1 Centralized Counting for Mobility Between Multiple Service Areas and 5GS-EPS Interworking

In embodiments of the present disclosure, a new centralized node is deployed to handle UEs that move between services areas (SAs) where multiple NSACFs are deployed, and when the UE cannot be admitted in the new service by the local NSACF because the maximum number of UEs has been reached. There are three mobility scenarios addressed by embodiments of the present disclosure:
AMF mobility when the new AMF is in a new service area when the operator divided the PLMN into multiple service areas.
Handover between Fourth Generation (4G) and 5G in roaming cases where home routed is used for 4G, while the AMF is in the visited domain and where a shared count is used and configured in the central NSACF.
Handover between 4G and 5G in non-roaming cases, and where a shared count is used and configured in the central NSACF.

The current role of local NSACF in a Service Area (SA) is maintained for local admission. When a UE registers in a new SA, the UE is either:
a UE not moving from another SA, i.e. it performs initial registration. This can be referred to as type 1 UEs.
a UE moving from another SA where it was admitted. This can be referred to as type 2 UEs

UEs registering for the first time, i.e. they are not coming from an old SA-type 1 UEs, will be admitted if the local NSACF can admit them for the requested network slice(s) (note the conditions for admission are more than what is currently defined in Release 17 because of this new solution), otherwise the request is forwarded to the central NSACF. The central NSACF rejects the request and includes in the rejection response a new information element (IE) including instructions to the local NSACF for handling future incoming new registration requests for new UEs not arriving from other SAs. The central NSACF instructs the local NSACF, in this new IE, to reject future registration requests for the S-NSSAI(s) for new UEs until the number of registered UEs fall below a certain threshold, e.g. when admission is down to 80% the local NSACF can start accepting registration again for a S-NSSAI for new UEs. This threshold depends on the central NSACF busy status, and its value is implementation dependent. In one embodiment, the instructions may also include a request to adjust the quota (i.e., the maximum number of registered UEs allowed at the local NSACF) for the network slice(s) at the local NSACF. This adjustment may be an increase or decrease to the quota. Further, in one embodiment, the threshold above is defined as a percentage where this percentage is applied to the adjusted quota.

UEs moving from old SAs-type 2 UEs must be admitted in a new SA where they register. To enable that, and if the local NSACF in the new SA is out of quota because the maximum number of Registered UEs for the requested slice(s) has been reached, the local NSACF forwards the request to the central NSACF, including an indication that this request is for a UE moving in a new SA from an old SA. The central NSACF handles the UE, creates the needed entry as a local NSACF currently does, increases the count for the slice(s). The central NSACF then returns the response to the local NSACF and includes instructions in the response for the local NSACF for handling future incoming new registration requests for new UEs not arriving from other SAs. The central NSACF instructs the local NSACFs to reject future registration requests for a S-NSSAI for all new UEs until the number of registered UEs fall below a certain threshold, e.g., when its admission is down to 80% the local NSACF can start accepting registration again. This threshold depends on the central NSACF busy status. In one embodiment, the instructions may also include a request to adjust the quota (i.e., the maximum number of registered UEs allowed at the local NSACF) for the network slice(s) at the local NSACF. This adjustment may be an increase or decrease to the quota. Further, in one embodiment, the threshold above is defined as a percentage where this percentage is applied to the adjusted quota.

The locals NSACF are provisioned with the necessary quota prior to any admission. The central NSACF keeps a sufficient reserve to enable it to handle UEs moving between SAs and ensure their admission if the local NSACFs cannot accept them due to their admission quota being depleted in the local NSACFs.

The central NSACF instructions to local NSACFs for handling future requests for new UEs when local NSACFs are not able to accept any more UEs for a S-NSSAI(s) allow the central NSACF to control rejections of future request for new UE registration requests up to the threshold it deems safe for it to allow the central NSACF to deal with any UEs moving between SAs. That threshold depends on the central NSACF implementation and is implementation specific. It is to be noted that the local NSACF interacts with the central NSACF when it is unable to accept any Registration because of its depleted quota regardless of if the UE is admitted in an old SA or not.

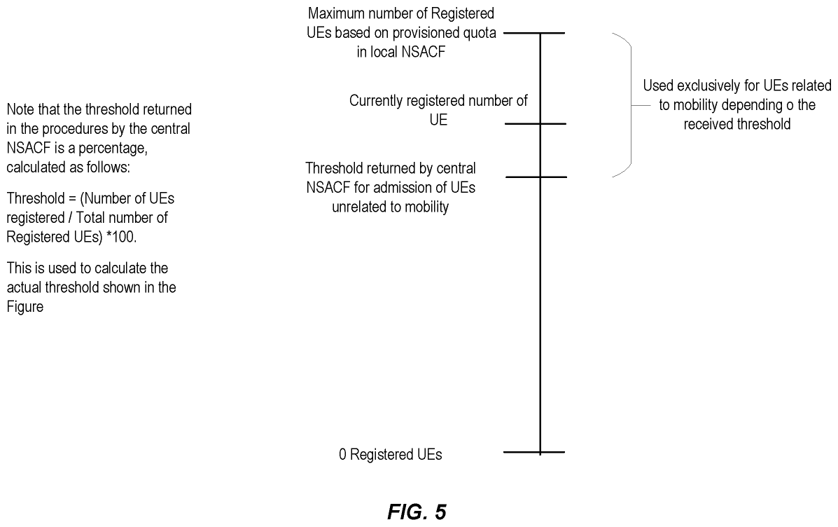

FIG. 5 illustrates the above concepts. In particular, FIG. 5 illustrates the maximum number of registered UEs allowed a the local NSACF, the currently registered number of UEs at the local NSACF, and the threshold returned by the central NSACF for admission of UEs unrelated to mobility.

The central NSACF additionally has the same ability to instruct local NSACFs in responses associated with requests received from local NSACF for decreasing the count for the number of registered UEs for those UEs the central NSACF hold their entries. Hence, the framework provides complete flexibility to quicky adapt to any situation.

Finally, a returned value of 100 by the central NSACF to a local NSACF has a special meaning and instructs the local NSACF to check with the central NSACF for every new request received by the local NSACF regardless. This enhances the flexibility of the proposed framework and permit quick adaptation.

The local NF can be configured in this option with the central NSACF, or can discover the central NSACF as per the section herein entitled “Discovery of Central NSACF”, or can receive the information from the AMF/SMF.

In summary, central NSACFs store UEs related information only for type 2 UEs, i.e. UEs that are moving in from an old SA after being admitted to a new SA where they can't be admitted due to the maximum number of Registered UEs have been reached.

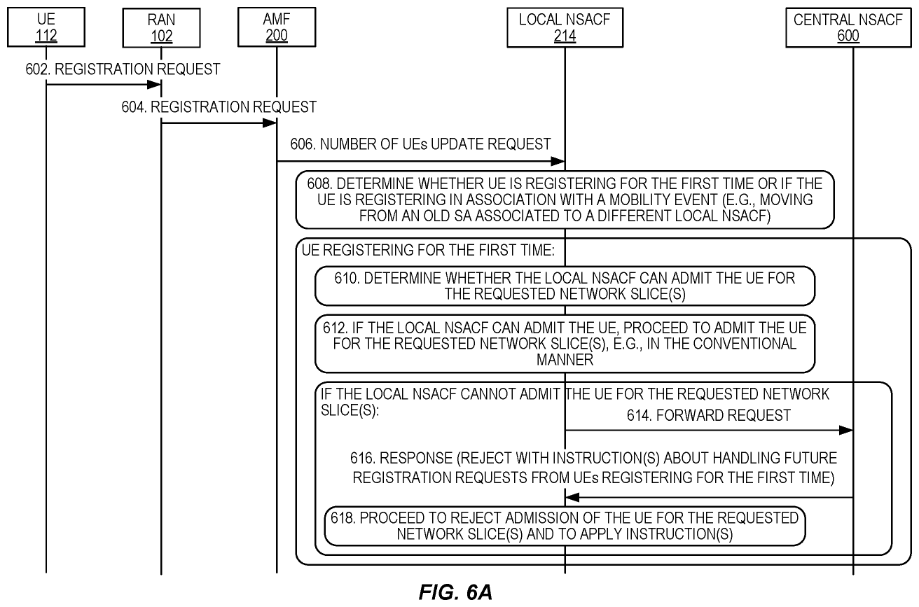

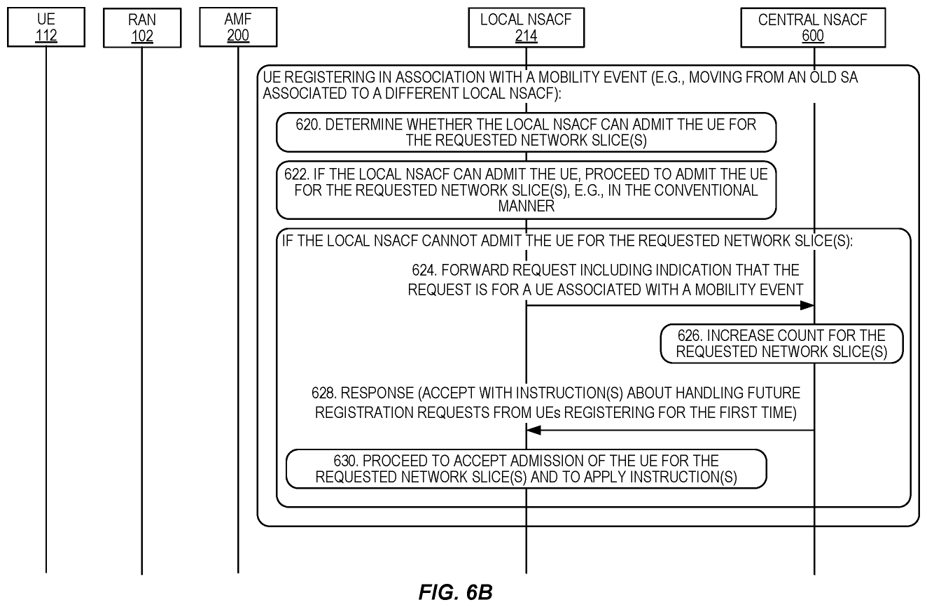

FIGS. 6A and 6B illustrates a procedure involving a central NSACF 600 in accordance with one example embodiment of the present disclosure. As illustrated, a UE 112 sends a registration request for one or more requested network slices to the RAN 102 (step 602), which in turn sends the request to the AMF 200 (step 604). As part of the registration procedure, the AMF 200 sends, to the local NSACF 214, a request to update the number of registered UEs for the requested network slice(s) (step 606). The local NSACF 214 determines whether the UE 112 associated to the request is registering for the first time (e.g., is not registering in association with a mobility event) or is registering in association with a mobility event (e.g., in association with moving from an old service area associated to a different local NSACF).

If the UE 112 is registering for the first time, as described above, the local NSACF 214 determines whether the local NSACF 214 can admit the UE for the requested network slice(s) (step 610). For example, the local NSACF 214 determines whether it has reached the maximum number of registered UEs for the requested network slice(s) or, if the local NSACF 214 has received instructions from the central NSACF 600 about how to handle requests for UEs for which the registration is a first registration (i.e., not associated to a mobility event), the local NSACF 214 determines whether it has reached the threshold number of registered UEs defined by the instructions received from the central NSACF 600, as described above. If the local NSACF 214 determines that the UE 112 can be admitted for the requested network slice(s), the local NSACF 214 performs action(s) to admit the UE 112 to the requested network slice(s) (e.g., sends a respective response to the AMF 200) (step 612). If the local NSACF 214 determines that the UE 112 cannot be admitted for the requested network slice(s), the local NSACF 214 forwards the request to update the number of registered UEs for the requested network slice(s) to the central NSACF 600 (step 614). The central NSACF 600 returns a response that rejects admission of the UE 112 to the requested network slice(s) and includes instructions from the central NSACF 600 about how the local NSACF 214 is to handle future requests for UEs that are not associated to mobility events (616). As described above, the instructions may be included in in the rejection response as a new information element (IE). The instructions instruct the local NSACF 214 to reject future registration requests for the requested network slice(s) for new UEs (UEs for which the registration is a first registration, i.e., not associated with a mobility event) until the number of registered UEs for the requested network slice(s) falls below a certain threshold. In one embodiment, the instructions may also include a request to adjust the quota (i.e., the maximum number of registered UEs allowed at the local NSACF) for the network slice(s) at the local NSACF. This adjustment may be an increase or decrease to the quota. Further, in one embodiment, the threshold above is defined as a percentage where this percentage is applied to the adjusted quota. The local NSACF 214 then proceeds to reject admission of the UE 112 for the requested network slice(s) (e.g., by sending a respective response to the AMF 200) and to apply the instruction(s) received from the central NSACF 600 (e.g., in step 610 when processing future requests for UEs requesting to register with the network slice(s) for the first time) (step 618).

If the local NSACF 214 determines that the UE 112 is requesting registration for the network slice(s) in association with a mobility event (e.g., from an old service area associated to a different local NSACF), the local NSACF 214 then determines whether it can admit the UE 112 for the requested network slice(s) (step 620). In this case, the local NSACF 214 makes this determination based on, e.g., whether the local NSACF 214 has reached its quota of registered UEs for the requested network slice(s). If the local NSACF 214 determines that the UE 112 can be admitted for the requested network slice(s), the local NSACF 214 performs action(s) to admit the UE 112 to the requested network slice(s) (e.g., sends a respective response to the AMF 200) (step 622). If the local NSACF 214 determines that the UE 112 cannot be admitted for the requested network slice(s), the local NSACF 214 forward the request to update the number of registered UEs for the requested network slice(s) to the central NSACF 600, where the request includes an indication that the request is associated to a UE for which the registration is requested in association with a mobility event (step 624). In response, the central NSACF 600 creates an entry as a local NSACF currently does, increases the count for the network slices slice(s) (step 626), and sends a response to the local NSACF 214 (step 628). The response indicates that the UE 112 is admitted (i.e., the response is an accept response), and the response includes instructions to the local NSACF 214 for handling future incoming new registration requests for new UEs that are requesting registration for the first time (i.e., not in association with a mobility event). As described above, the instructions may be included in in the accept response as a new information element (IE). The instructions instruct the local NSACF 214 to reject future registration requests for the requested network slice(s) for new UEs (UEs for which the registration is a first registration, i.e., not associated with a mobility event) until the number of registered UEs for the requested network slice(s) falls below a certain threshold. In one embodiment, the instructions may also include a request to adjust the quota (i.e., the maximum number of registered UEs allowed at the local NSACF) for the network slice(s) at the local NSACF. This adjustment may be an increase or decrease to the quota. Further, in one embodiment, the threshold above is defined as a percentage where this percentage is applied to the adjusted quota. The local NSACF 214 then proceeds to accept admission of the UE 112 for the requested network slice(s) (e.g., by sending a respective response to the AMF 200) and to apply the instruction(s) received from the central NSACF 600 (e.g., in step 610 when processing future requests for UEs requesting to register with the network slice(s) for the first time) (step 630).

### 5GS Only Slices

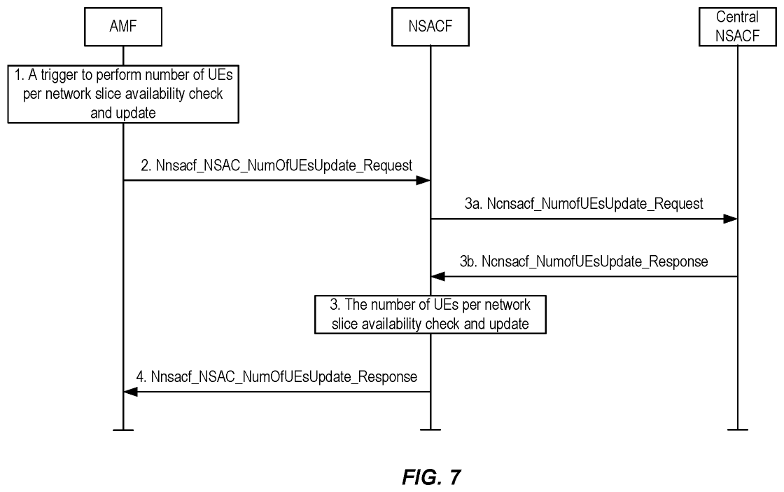

FIG. 7 illustrates one embodiment of a procedure followed by a local NSACF 214. This procedure is identical to the procedure specified in 3GPP TS 23.502 (see, e.g., V17.3.0) section 4.2.11.2 but with the changes as noted below. First, an excerpt of 3GPP TS 23.502, Section 4.2.11.12 is provided. Then, a description of the changes to the procedure in accordance with this embodiment of the present disclosure is provided.

***** Start Excerpt from 3GPP TS 23.502, Section 4.2.11.12 *****
1. If the AMF is not aware of which NSACF to communicate, the AMF performs NSACF discovery as described in clause 6.3.22 of TS 23.501 [2] and in clause 5.2.7.3.2. The AMF triggers the Number of UEs per network slice availability check and update procedure to update the number of UEs registered with a network slice when a network slice subject to NSAC is included in the Allowed NSSAI (i.e. the AMF requests to register the UE with the S-NSSAI) or removed from the Allowed NSSAI (i.e. the AMF requests to de-register the UE from the S-NSSAI) for a UE. The trigger event at the AMF also includes the change of Allowed NSSAI in case of inter-AMF mobility. The procedure is triggered in the following cases:
   At UE Registration procedure, according to clause 4.2.2.2.2 (including Registration types of Initial Registration or Mobility Registration Update in inter-AMF mobility in CM-CONNECTED or CM-IDLE state):
      before the Registration Accept in step 21 if the EAC mode is active; or
      after the Registration Accept message if the EAC mode is not active;
   At UE Deregistration procedure, as per clause 4.2.2.3, after the Deregistration procedure is completed;
   At UE Configuration Update procedure (which may result from NSSAA procedure or subscribed S-NSSAI change):
      before the UE Configuration Update message if the EAC mode is active and the update flag is to increase; or
      after the UE Configuration Update message if the EAC mode is active and the update flag is to decrease; or
      after the UE Configuration Update message if the EAC mode is not active.
NOTE 1: Depending on the deployment, there may be different NSACF for different S-NSSAI subject to NSAC, and hence, during the registration, AMF triggers the Number of UEs per network slice availability check and update procedure to multiple NSACFs.
2. The AMF sends Nnsacf_NSAC_NumOfUEsUpdate_Request message to the NSACF. The AMF includes in the message the UE ID, access type to which the Allowed NSSAI is applied, the S-NSSAI(s), the NF ID and the update flag which indicates whether the number of UEs registered with the S-NSSAI(s) is to be increased when the UE has gained registration to network slice(s) subject to NSAC or the number of UEs registered with the S-NSSAI(s) is to be decreased when the UE has deregistered from S-NSSAI(s) or could not renew its registration to an S-NSSAI subject to NSAC.
   If this is the first time to perform NSAC procedure for the S-NSSAI towards the NSACF, the AMF includes notification endpoint for EAC Notification to implicitly subscribe the EAC notification for the S-NSSAI from the NSACF.
3. The NSACF determines whether the Access Type provided by the AMF is configured for the NSAC based on its configuration. If the Access Type is not configured for the NSAC, the NSACF always accepts the request from the AMF without increasing or decreasing the number of UEs. If the Access Type is configured for the NSAC, the NSACF updates the current number of UEs registered for the S-NSSAI, i.e. increases or decrease the number of UEs registered per network slice based on the information provided by the AMF in the update flag parameter.
   If the update flag parameter from the AMF indicates increase, the following applies:
      If the UE ID is already in the list of UEs registered with the network slice, the current number of UEs is not increased as the UE has already been counted as registered with the network slice. The NSACF creates a new entry associated with this new update and shall also maintain the old entry associated with previous update. The multiple entries for the same UE ID in the NSACF are differentiated based on the NF ID of the NF sending the update request. The NSACF removes the entry associated with the NF ID upon reception of a request having update flag indicating decrease.
NOTE 2: The use case of having two or more entries in the NSACF for the same UE can happen during (a) inter-AMF mobility when the new AMF request update to the NSACF before the old AMF sends request to deregister the UE; or (b) PDN connections establishment in the EPC when multiple SMF+PGW-Cs (i.e. used for different PDN Connections associated with the same S-NSSAI) send update requests for maximum number of UEs to the NSACF.
NOTE 3: To handle AMF graceful removal, the NSACF can subscribe for unavailability notifications with the AMF (directly or via NRF) as described in clause 5.21.2.2, and act accordingly, e.g. update the NF ID with the target AMF ID.
   If the UE ID is not in the list of UE IDs registered with the network slice and the maximum number of UEs registered with the network slice has not been reached yet, the NSACF adds the UE ID in the list of UEs registered with the network slice as a new entry associated with this new update and increases the current number of the UEs registered with the network slice. If the UE ID is not in the list of UEs registered with that S-NSSAI and the maximum number of UEs for that S-NSSAI has already been reached, then the NSACF returns a result parameter indicating that the maximum number of UEs registered with the network slice has been reached.
   If the update flag parameter from the AMF indicates decrease and if there is only one entry associated with the UE ID, the NSACF removes the UE ID from the list of UEs registered with the network slice for each of the S-NSSAI(s) indicated in the request from the AMF and also the NSACF decreases the number of UEs per network slice that is maintained by the NSACF for each of these network slices. If there are multiple entries associated with the UE ID, the NSACF removes the entry associated with the NF ID but the UE ID is kept in the list of UEs registered with the S-NSSAI.
   The NSACF takes access type into account for increasing and decreasing the number of UEs per network slice as described in clause 5.15.11.1 of TS 23.501 [2].
   The NSACF stores the notification endpoint for EAC Notification associated with the S-NSSAI if it is received from the AMF. The NSACF can use this AMF notification endpoint to update the EAC mode as described in clause 4.2.11.3.
NOTE 4: This enables the NSACF to maintain up-to-date information about the AMFs serving the S-NSSAIs.
4. The NSACF returns the Nnsacf_NSAC_NumOfUEsUpdate_Response message including Result indication per S-NSSAI. The Result indication includes either ‘maximum number of UEs registered with the network slice reached’ or ‘maximum number of UEs registered with the network slice not reached’.
   At UE Registration procedure, if only some of the S-NSSAIs reached the maximum number of UEs per S-NSSAI, the AMF sends a Registration Accept message to the UE in which the AMF includes the rejected S-NSSAI(s) in the rejected NSSAI list for which the NSACF has indicated that the maximum number of UEs per network slice has been reached, and for each rejected S-NSSAI the AMF includes a reject cause set to ‘maximum number of UEs per network slice reached’ and optionally a back-off timer.
   When for all the Requested S-NSSAI(s) provided in step 2 the NSACF returned the maximum number of UEs per network slice has been reached and if one or more subscribed S-NSSAIs are marked as default in the subscription data and not subject to NSAC, the AMF can decide to include these Default Subscribed S-NSSAIs in the Allowed NSSAI. Otherwise, the AMF rejects the UE request for registration. In the Registration Reject message, the AMF includes the rejected S-NSSAI(s) in the rejected NSSAI parameter, and for each rejected S-NSSAI the AMF includes a reject cause to indicate that the maximum number of UEs per network slice has been reached and optionally a back-off timer.
NOTE 5: If the use case requires the UE to remain reachable at all times with at least one slice, it is recommended that at least one of the Subscribed S-NSSAIs is marked as the default S-NSSAI which is not subject to NSAC. This will ensure the UE is able to access to services even when maximum number of UEs per network slice has been reached.
   ***** End Excerpt from 3GPP TS 23.502, Section 4.2.11.12 *****

A description of the changes to the procedure in accordance with this embodiment of the present disclosure is as follows:
Steps 1-2 are the same as the existing procedure defined in section 4.2.11.12 of TS 23.502.
In step 3 of section 4.2.11.2, the following conditions are handled:
   If the request is an increase and the local NSACF has an existing entry for the UE, then step 3 is executed as is.
   If the request is a decrease and the local NSACF has an existing entry for the UE then step 3, of clause 4.2.11.2 of TS 23.502, is executed as is.
   If the request is an increase and the local NSACF does not have an existing entry for the UE, the following applies:
      If the UE registration is unrelated to mobility, i.e. type 1 UEs, and the local NSACF is able to admit the UE, the local NSACF checks the instructions received/stored from the central NSACF, if any, and ensures that it is compliant. If an instruction is found and the local NSACF is compliant, it accepts the request and executes step 3 of clause 4.2.11.2 of TS 23.502, as is. If the local NSACF is not able to admit the UE because of the instruction threshold (number of Registered UEs are above the threshold), then the local NSACF rejects the request and executes step 3 of clause 4.2.11.2 of TS 23.502, as is.
      If the UE registration is related to mobility, i.e. type 2 UEs, meaning that the UE is, e.g., coming in from an AMF belonging to old SA, and the local NSACF is able to admit the UE, then the local NSACF accepts the request and executes step 3 as is.
      If the local NSACF is not able to admit the UE because the maximum number of Registered UEs has been reached, then the local NSACF sends the request to the central NSACF, includes an indication in the request that the UE has already been admitted in an old SA, and waits for a response before responding to the AMF. The local NSACF discovers the central NSACF if it already has not done so or if it not pre-configured with the central NSACF
      The central NSACF creates an entry for the incoming request, similar to what the local NSACF does, and stores same information. The central NSACF calculates the threshold to be sent back to the local NSACF for admission based on in its own internal logic, and includes the instruction in the response back to the local NSACF. The threshold is a percentage form, e.g. 80% which implies that the local NSACF accepts admission for new UEs registering in when it is occupancy is down to 80%. In one embodiment, the central NSACF may also include, e.g., in the response, an instruction to the local NSACF to change (e.g., increase or decrease) it's quota (i.e., maximum number of Registered UEs) for the requested network slices. In one embodiment, a returned value of 100 has a special meaning and instructs the local NSACF to check with the central NSACF for every new request received by the local NSACF regardless. This is step 3a in the Figure below.
   If the request is a decrease, and the local NSACF found the entry, the local NSACF executes step 3 as is
   If the request is a decrease, and the local NSACF did not found the entry, the local NSACF sends the request to the central NSACF which has the entry. The central NSACF deletes the entry, calculates the thresholds to be provided in the instruction IE for the local NSACF, and returns a response including the instructions for the threshold (and optionally instruction to change the quota for the requested network slice(s) at the local NSACF). This is step 3a shown in FIG. 7.
In step 4 the local NSACF waits for pending requests to the central NSACF sent in step 3a in FIG. 7, before sending a response to the UE that merges the received response from the central NSACF. The local NSACF updates any instructions regarding a slice received from the central NSACF.
   5GS-EPS Interworking with EPS Counting Active

In one embodiment, there is a shared count for maximum number of Registered UEs for interworking between 5GS and EPS. The count can be performed by a central NSACF NF dedicated for 5GS-EPC interworking, or the central NSACF NF used for 5GS slices can be used.

### Roaming

Roaming is covered by embodiments of the solution(s) described herein. The AMF in the VPLMN discovers the central NSACF used in the HPLMN if an incoming inbound roamer previously admitted cannot be handled by the AMF in the VPLMN.

### UE PDU Session Admission

In one embodiment, for UE PDU session admission, SMFs use the central NSACF in the same fashion as the AMF for the number of registered UEs, with the distinction that new services, different than the ones used by the AMF so as to handle the number of PDU sessions, are used in the central NSACF.

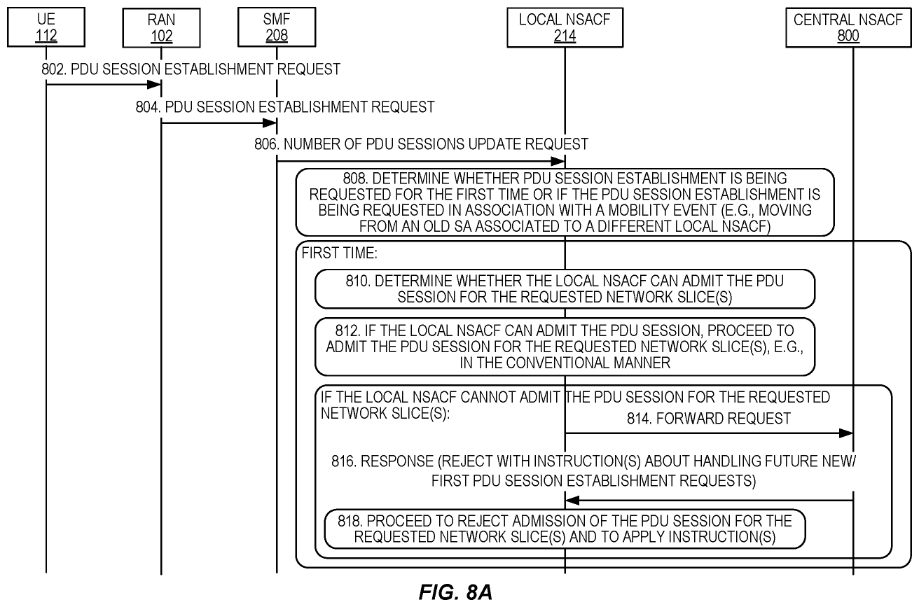

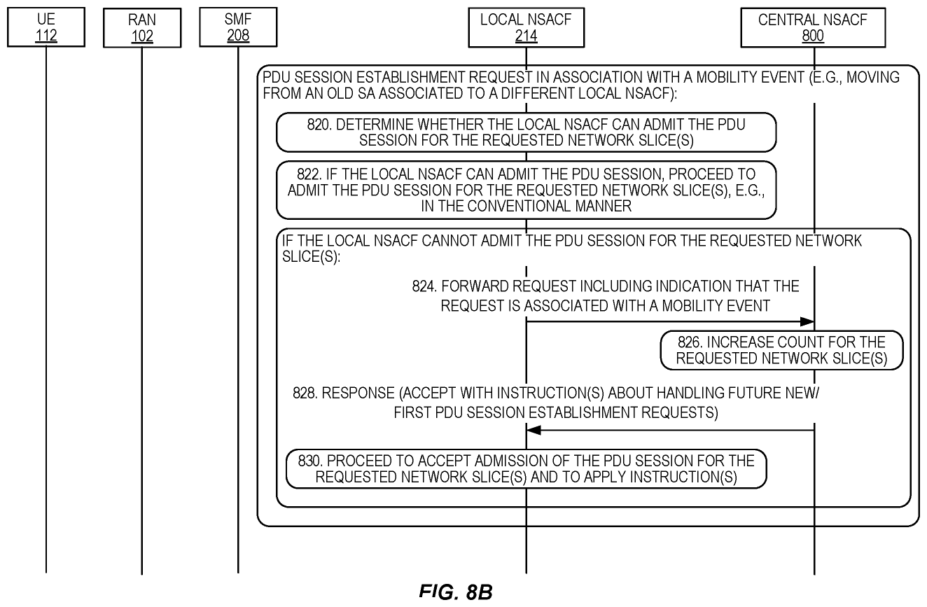

This is illustrated in FIGS. 8A and 8B illustrates a procedure involving a central NSACF 800 in accordance with one example embodiment of the present disclosure. As illustrated, a UE 112 sends a PDU session establishment request for one or more requested network slices to the RAN 102 (step 802), which in turn sends the request to the SMF 208 (step 804). As part of the PDU session establishment procedure, the SMF 208 sends, to the local NSACF 214, a request to update the number of PDU sessions for the requested network slice(s) (step 806). The local NSACF 214 determines whether the PDU session establishment request from the UE 112 is a first PDU session establishment request (i.e., a request that is not associated with a mobility event) or a PDU session establishment request associated with a mobility event (e.g., in association with moving from an old service area associated to a different local NSACF).

If the PDU session establishment request is a first PDU session establishment request (i.e., is not associated with a mobility event), as described above, the local NSACF 214 determines whether the local NSACF 214 can admit the requested PDU session for the requested network slice(s) (step 810). For example, the local NSACF 214 determines whether it has reached the maximum number of PDU sessions for the requested network slice(s) or, if the local NSACF 214 has received instructions from the central NSACF 800 about how to handle requests for PDU sessions for which the request is a first registration (i.e., not associated to a mobility event), the local NSACF 214 determines whether it has reached the threshold number of PDU sessions defined by the instructions received from the central NSACF 800, as described above. If the local NSACF 214 determines that the PDU session can be admitted for the requested network slice(s), the local NSACF 214 performs action(s) to admit the PDU session to the requested network slice(s) (e.g., sends a respective response to the SMF 208) (step 812). If the local NSACF 214 determines that the PDU session cannot be admitted for the requested network slice(s), the local NSACF 214 forward the request to update the number of PDU sessions for the requested network slice(s) to the central NSACF 800 (step 814). The central NSACF 800 returns a response that rejects admission of the PDU session to the requested network slice(s) and includes instructions from the central NSACF 800 about how the local NSACF 214 is to handle future requests for PDU sessions for the requested network slice(s) that are not associated to mobility events (816). As described above, the instructions may be included in in the rejection response as a new information element (IE). The instructions instruct the local NSACF 214 to reject future PDU session establishment requests for the requested network slice(s) for new PDU sessions (PDU sessions not associated with a mobility event) until the number of PDU sessions for the requested network slice(s) falls below a certain threshold. In one embodiment, the instructions may also include a request to adjust the quota (i.e., the maximum number of PDU sessions allowed at the local NSACF) for the network slice(s) at the local NSACF. This adjustment may be an increase or decrease to the quota. Further, in one embodiment, the threshold above is defined as a percentage where this percentage is applied to the adjusted quota. The local NSACF 214 then proceeds to reject admission of the PDU session for the requested network slice(s) (e.g., by sending a respective response to the SMF 208) and to apply the instruction(s) received from the central NSACF 800 (e.g., in step 810 when processing future requests for PDU sessions on the network slice(s) for the first time) (step 818).

If the local NSACF 214 determines that the UE 112 is requesting PDU session establishment for the network slice(s) in association with a mobility event (e.g., from an old service area associated to a different local NSACF), the local NSACF 214 then determines whether it can admit the PDU session for the requested network slice(s) (step 820). In this case, the local NSACF 214 makes this determination based on, e.g., whether the local NSACF 214 has reached its quota of registered UEs for the requested network slice(s). If the local NSACF 214 determines that the PDU session can be admitted for the requested network slice(s), the local NSACF 214 performs action(s) to admit the PDU session to the requested network slice(s) (e.g., sends a respective response to the SMF 208) (step 822). If the local NSACF 214 determines that the PDU session cannot be admitted for the requested network slice(s), the local NSACF 214 forward the request to update the number of PDU sessions for the requested network slice(s) to the central NSACF 800, where the request includes an indication that the request is associated to a UE for which establishment of the PDU session is requested in association with a mobility event (step 824). In response, the central NSACF 800 creates an entry as a local NSACF currently does, increases the count for the PDU sessions for the network slices slice(s) (step 826), and sends a response to the local NSACF 214 (step 828). The response indicates that the PDU session is admitted (i.e., the response is an accept response), and the response includes instructions to the local NSACF 214 for handling future incoming new PDU session establishment requests (i.e., PDU session establishment requests that are not in association with a mobility event). As described above, the instructions may be included in in the accept response as a new information element (IE). The instructions instruct the local NSACF 214 to reject future PDU session establishment requests for the requested network slice(s) for new PDU sessions (PDU sessions for which establishment is requested for the first time, i.e., not in association with a mobility event) until the number of PDU sessions for the requested network slice(s) falls below a certain threshold. In one embodiment, the instructions may also include a request to adjust the quota (i.e., the maximum number of PDU sessions allowed at the local NSACF) for the network slice(s) at the local NSACF. This adjustment may be an increase or decrease to the quota. Further, in one embodiment, the threshold above is defined as a percentage where this percentage is applied to the adjusted quota. The local NSACF 214 then proceeds to accept admission of the PDU session for the requested network slice(s) (e.g., by sending a respective response to the SMF 208) and to apply the instruction(s) received from the central NSACF 800 (e.g., in step 810 when processing future requests for new/first PDU session establishments with the network slice(s)) (step 830).

### Discovery of Central NSACF

Currently following factors may be considered by the NF consumer for NSACF selection:
S-NSSAI(s).
NSACF Serving Area information. The NSACF service area is related to the local of the NF consumer.
NOTE: Each Serving Area is unique and unambiguously identified.

For central NSACF, a PLMN shall include a service area unambiguously identified for that purpose. This could be as an example, the PLMN ID. Stage 3 makes the final determination. This enables an AMF/SMF utilizing centralized counting to be able to select the appropriate NSACF.

### Services Supported by Central NSACF

The central NSACF supports the same services as local NSACF as defined in section 5.2.21 of TS 23.502.

Both the local NSACF and central NSACF support additionally the following:
Service Operation name: Nnsacf_NSAC_NumOfUEsUpdate: A new optional parameter is added by local NSACF to tell the central NSACF that this is a UE who has been admitted in another AMF.
   The response from central NSACF to local NSACF as well includes instructions for the local NSACF on how to handle future submissions. The value 100 has a special meaning requiring the local NSACF to check every new admission with the central NSACF.
Service Operation name: Nnsacf_NSAC_NumOfPDUsUpdate:
   Same impacts as described above but for local NSACF associated with the SMF.

### NEF Monitoring in the Presence of Central NSACF

3GPP TS 23.502, clause 4.15.3.2.10 describes a procedure in which an Application Function (AF) subscribes to receive the registered number of UEs, or the number of PDU sessions, in a specific S-NSSAI. The impacts on TS 23.502, clause 4.15.3.2.10 in regard to NEF monitoring in the presence of the central NSACF can be summarized as follows:
When an AF subscribes to the NEF for the number of UEs or the number of PDU sessions for a S-NSSAI, NEF queries the NRF for a list of NSACFs responsible for the requested S-NSSAI. The central NSACF is included in the list of NSACFs retrieved from the NRF. The NEF then subscribes to the NSACFs, including the central NSACF, responsible the requested S-NSSAI for events related to the requested S-NSSAI. By subscribing to the central NSACF, the NEF ensures that a complete count is provided and notified to the subscribed AF.

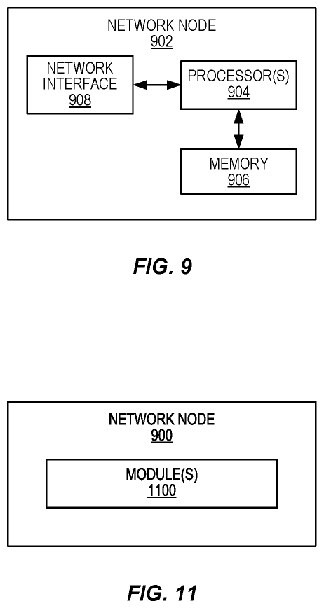

FIG. 9 is a schematic block diagram of a network node 900 according to some embodiments of the present disclosure. Optional features are represented by dashed boxes. The network node 900 may be, for example, a core network node that implements a NF (e.g., AMF 200, SMF 208, (local) NSACF 314, or central NSACF 600) or a network node that implements all or part of the functionality of an NF (e.g., all or part of the functionality of the AMF 200, SMF 208, (local) NSACF 314, or central NSACF 600 described herein). As illustrated, the network node 900 includes a one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. The one or more processors 904 operate to provide one or more functions of the network node 900 as described herein (e.g., one or more functions of the AMF 200, SMF 208, (local) NSACF 314, or central NSACF 600 described herein). In some embodiments, the function(s) are implemented in software that is stored, e.g., in the memory 906 and executed by the one or more processors 904.

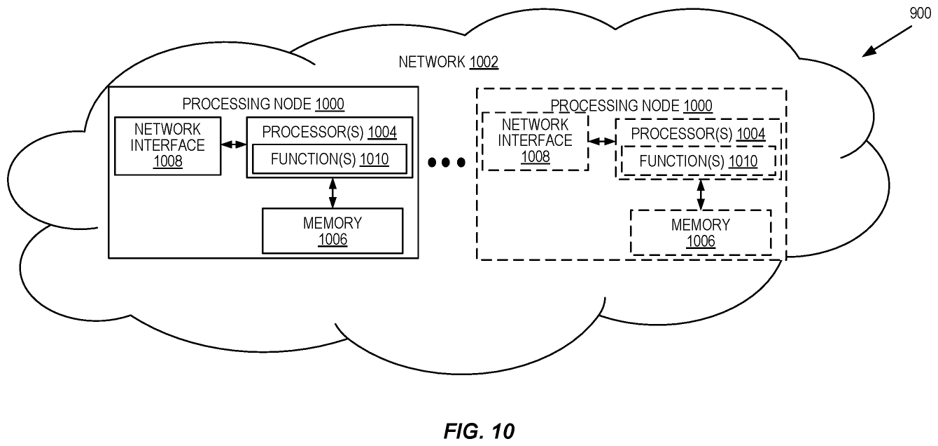

FIG. 10 is a schematic block diagram that illustrates a virtualized embodiment of the network node 900 according to some embodiments of the present disclosure. Again, optional features are represented by dashed boxes. As used herein, a “virtualized” network node is an implementation of the network node 900 in which at least a portion of the functionality of the network node 900 is implemented as a virtual component(s) (e.g., via a virtual machine(s) executing on a physical processing node(s) in a network(s)). As illustrated, in this example, the network node 900 includes one or more processing nodes 1000 coupled to or included as part of a network(s) 1002. Each processing node 1000 includes one or more processors 1004 (e.g., CPUs, ASICs, FPGAS, and/or the like), memory 1006, and a network interface 1008. In this example, functions 1010 of the network node 900 described herein (e.g., one or more functions of the AMF 200, SMF 208, (local) NSACF 314, or central NSACF 600 described herein) are implemented at the one or more processing nodes 1000 or distributed across the two or more processing nodes 1000 in any desired manner. In some particular embodiments, some or all of the functions 1010 of the network node 900 described herein are implemented as virtual components executed by one or more virtual machines implemented in a virtual environment(s) hosted by the processing node(s) 1000.

In some embodiments, a computer program including instructions which, when executed by at least one processor, causes the at least one processor to carry out the functionality of the network node 900 or a node (e.g., a processing node 1000) implementing one or more of the functions 1010 of the network node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the network node 900 according to some other embodiments of the present disclosure. The network node 900 includes one or more modules 1100, each of which is implemented in software. The module(s) 1100 provide the functionality of the network node 900 described herein. This discussion is equally applicable to the processing node 1000 of FIG. 10 where the modules 1100 may be implemented at one of the processing nodes 1000 or distributed across multiple processing nodes 1000.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

Embodiment 1: A method comprising:
at a local Network Slice Admission Control Function, NSACF, (314):
   receiving (606) a request to update a number of registered User Equipments, UEs, for a network slice in association with a registration request for a particular UE for the network slice;
   determining (610; 620) that the local NSACF (314) cannot admit the particular UE for the network slice;
   responsive to determining (610; 620) that the local NSACF (314) cannot admit the particular UE for the network slice:
      sending (614; 624) a request to update the number of registered UEs for the network slice to a central NSACF (600);
at the central NSACF (600):
   receiving (614; 624) the request from the local NSACF (314);
   sending (616; 628) a response to the local NSACF (314), wherein:
      the response indicates that admission of the particular UE to the network slice is either accepted or rejected; and
      the response comprises instructions about handling of future requests to update the number of registered UEs for the network slice at the local NSACF (314) received in association with registration requests for the network slice made by UEs for which the registration requests are new registration requests;
at the local NSACF (314):
   receiving (616; 628) the response from the central NSACF (600);
   rejecting (618) or accepting (630) admission of the particular UE for the particular network slice in accordance with the response received from the central NSACF (600); and
   applying (618; 630) the instructions comprised in the response when determining whether the local NSACF (314) can admit future requests to update the number of registered UEs for the network slice at the local NSACF (314) received in association with respective registration requests for the network slice made by respective UEs for which the registration requests are new registration requests.

Embodiment 2: The method of embodiment 1 wherein the particular UE is a UE for which the registration request is a new registration request, and the response from the central NSACF (600) to the local NSACF (314) indicates that admission of the particular UE to the network slice is rejected.

Embodiment 3: The method of embodiment 1 wherein the particular UE is a UE for which the registration request is made in association with a mobility event for the particular UE, and the response from the central NSACF (600) to the local NSACF (314) indicates that admission of the particular UE to the network slice is accepted.

Embodiment 4: The method of any of embodiments 1 to 3 wherein the instructions comprise an instruction to not admit UEs for which respective registration requests are new registration requests until the number of registered UEs for the network slice at the local NSACF (314) is less than a threshold.

Embodiment 5: The method of embodiment 4 wherein the threshold is a percentage of the defined maximum number of registered UEs for the network slice that can be admitted by the local NSACF (314).

Embodiment 6: The method of embodiment 4 wherein the instructions further comprise an instruction to change the defined maximum number of registered UEs for the network slice that can be admitted by the local NSACF (314), and the threshold is a percentage of the changed maximum number of registered UEs for the network slice that can be admitted by the local NSACF (314).

Embodiment 7: A method performed by a local Network Slice Admission Control Function, NSACF, (314), the method comprising:
receiving (606) a request to update a number of registered User Equipments, UEs, for a network slice in association with a registration request for a particular UE for the network slice;
determining (610; 620) that the local NSACF (314) cannot admit the particular UE for the network slice;
responsive to determining (610; 620) that the local NSACF (314) cannot admit the particular UE for the network slice, sending (614; 624) a request to update the number of registered UEs for the network slice to a central NSACF (600);
receiving (616; 628) a response from the central NSACF (600), wherein:
   the response indicates that admission of the particular UE to the network slice is either accepted or rejected; and
   the response comprises instructions about handling of future requests to update the number of registered UEs for the network slice at the local NSACF (314) received in association with registration requests for the network slice made by UEs for which the registration requests are new registration requests;
rejecting (618) or accepting (630) admission of the particular UE for the particular network slice in accordance with the response received from the central NSACF (600); and
applying (618; 630) the instructions comprised in the response when determining whether the local NSACF (314) can admit future requests to update the number of registered UEs for the network slice at the local NSACF (314) received in association with respective registration requests for the network slice made by respective UEs for which the registration requests are new registration requests.

Embodiment 8: The method of embodiment 7 wherein the particular UE is a UE for which the registration request is a new registration request, and the response from the central NSACF (600) indicates that admission of the particular UE to the network slice is rejected.

Embodiment 9: The method of embodiment 7 wherein the particular UE is a UE for which the registration request is made in association with a mobility event for the particular UE, and the response from the central NSACF (600) indicates that admission of the particular UE to the network slice is accepted.

Embodiment 10: The method of any of embodiments 7 to 9 wherein the instructions comprise an instruction to not admit UEs for which respective registration requests are new registration requests until the number of registered UEs for the network slice at the local NSACF (314) is less than a threshold.

Embodiment 11: The method of embodiment 10 wherein the threshold is a percentage of the defined maximum number of registered UEs for the network slice that can be admitted by the local NSACF (314).

Embodiment 12: The method of embodiment 10 wherein the instructions further comprise an instruction to change the defined maximum number of registered UEs for the network slice that can be admitted by the local NSACF (314), and the threshold is a percentage of the changed maximum number of registered UEs for the network slice that can be admitted by the local NSACF (314).

Embodiment 13: A method performed by a central Network Slice Admission Control Function, NSACF, (600), the method comprising:
receiving (614; 624), from a local NSACF (314), a request to update the number of registered UEs for a network slice;
sending (616; 628) a response to the local NSACF (314), wherein:
   the response indicates that admission of the particular UE to the network slice is either accepted or rejected; and
   the response comprises instructions about handling of future requests to update the number of registered UEs for the network slice at the local NSACF (314) received in association with registration requests for the network slice made by UEs for which the registration requests are new registration requests.

Embodiment 14: The method of embodiment 13 wherein the particular UE is a UE for which the registration request is a new registration request, and the response sent from the central NSACF (600) to the local NSACF (314) indicates that admission of the particular UE to the network slice is rejected.

Embodiment 15: The method of embodiment 13 wherein the particular UE is a UE for which the registration request is made in association with a mobility event for the particular UE, and the response sent from the central NSACF (600) to the local NSACF (314) indicates that admission of the particular UE to the network slice is accepted.

Embodiment 16: The method of any of embodiments 13 to 15 wherein the instructions comprise an instruction to not admit UEs for which respective registration requests are new registration requests until the number of registered UEs for the network slice at the local NSACF (314) is less than a threshold.

Embodiment 17: The method of embodiment 16 wherein the threshold is a percentage of the defined maximum number of registered UEs for the network slice that can be admitted by the local NSACF (314).

Embodiment 18: The method of embodiment 16 wherein the instructions further comprise an instruction to change the defined maximum number of registered UEs for the network slice that can be admitted by the local NSACF (314), and the threshold is a percentage of the changed maximum number of registered UEs for the network slice that can be admitted by the local NSACF (314).

Embodiment 19: A network node adapted to perform the method of any of embodiments 7 to 18.

Embodiment 20: A method comprising:
at a local Network Slice Admission Control Function, NSACF, (314):
   receiving (806) a request to update a number of Protocol Data Unit, PDU, sessions for a network slice in association with a PDU session establishment request for a particular UE for the network slice;
   determining (810; 820) that the local NSACF (314) cannot admit a PDU session for the network slice;
   responsive to determining (810; 820) that the local NSACF (314) cannot admit a PDU session for the network slice:
      sending (814; 824) a request to update the number of PDU sessions for the network slice to a central NSACF (800);
at the central NSACF (800):
   receiving (814; 824) the request from the local NSACF (814);
   sending (816; 828) a response to the local NSACF (314), wherein:
      the response indicates that admission of a PDU session to the network slice is either accepted or rejected; and
      the response comprises instructions about handling of future requests to update the number of PDU sessions for the network slice at the local NSACF (314) received in association with PDU session establishment requests for the network slice made by UEs for which the PDU session establishment requests are not associated with a mobility event;
at the local NSACF (314):
   receiving (816; 828) the response from the central NSACF (800);
   rejecting (818) or accepting (830) admission of a PDU session for the particular UE for the particular network slice in accordance with the response received from the central NSACF (800); and
   applying (818; 830) the instructions comprised in the response when determining whether the local NSACF (314) can admit future requests to update the number of PDU sessions for the network slice at the local NSACF (314) received in association with respective PDU session establishment requests for the network slice made by respective UEs for which the PDU session establishment requests are not associated with a mobility event.

Embodiment 21: The method of embodiment 20 wherein the particular UE is a UE for which the PDU session establishment request is not associated with a mobility event, and the response from the central NSACF (800) to the local NSACF (314) indicates that admission of a PDU session for the particular UE to the network slice is rejected.

Embodiment 22: The method of embodiment 20 wherein the particular UE is a UE for which the PDU session establishment request is made in association with a mobility event for the particular UE, and the response from the central NSACF (800) to the local NSACF (314) indicates that admission of a PDU session for the particular UE to the network slice is accepted.

Embodiment 23: The method of any of embodiments 20 to 22 wherein the instructions comprise an instruction to not admit PDU sessions for which respective PDU session establishment requests are not associated with a mobility event until the number of PDU sessions for the network slice at the local NSACF (314) is less than a threshold.

Embodiment 24: The method of embodiment 23 wherein the threshold is a percentage of the defined maximum number of PDU sessions for the network slice that can be admitted by the local NSACF (314).

Embodiment 25: The method of embodiment 23 wherein the instructions further comprise an instruction to change the defined maximum number of PDU sessions for the network slice that can be admitted by the local NSACF (314), and the threshold is a percentage of the changed maximum number of PDU sessions for the network slice that can be admitted by the local NSACF (314).

Embodiment 26: A method performed by a local Network Slice Admission Control Function, NSACF, (314), the method comprising:
receiving (806) a request to update a number of Protocol Data Unit, PDU, sessions for a network slice in association with a PDU session establishment request for a particular UE for the network slice;
determining (810; 820) that the local NSACF (314) cannot admit a PDU session for the network slice;
responsive to determining (810; 820) that the local NSACF (314) cannot admit a PDU session for the network slice, sending (814; 824) a request to update the number of PDU sessions for the network slice to a central NSACF (800);
receiving (816; 828) a response from the central NSACF (600), wherein:
   the response indicates that admission of a PDU session to the network slice is either accepted or rejected; and
   the response comprises instructions about handling of future requests to update the number of PDU sessions for the network slice at the local NSACF (314) received in association with PDU session establishment requests for the network slice made by UEs for which the PDU session establishment requests are not associated with a mobility event;
rejecting (818) or accepting (830) admission of a PDU session for the particular UE for the particular network slice in accordance with the response received from the central NSACF (800); and
applying (818; 830) the instructions comprised in the response when determining whether the local NSACF (314) can admit future requests to update the number of PDU sessions for the network slice at the local NSACF (314) received in association with respective PDU session establishment requests for the network slice made by respective UEs for which the PDU session establishment requests are not associated with a mobility event.

Embodiment 27: The method of embodiment 26 the particular UE is a UE for which the PDU session establishment request is not associated with a mobility event, and the response from the central NSACF (800) indicates that admission of a PDU session for the particular UE to the network slice is rejected.

Embodiment 28: The method of embodiment 26 wherein the particular UE is a UE for which the PDU session establishment request is made in association with a mobility event for the particular UE, and the response from the central NSACF (800) indicates that admission of a PDU session for the particular UE to the network slice is accepted.

Embodiment 29: The method of any of embodiments 26 to 28 wherein the instructions comprise an instruction to not admit PDU sessions for which respective PDU session establishment requests are not associated with a mobility event until the number of PDU sessions for the network slice at the local NSACF (314) is less than a threshold.

Embodiment 30: The method of embodiment 29 wherein the threshold is a percentage of the defined maximum number of PDU sessions for the network slice that can be admitted by the local NSACF (314).

Embodiment 31: The method of embodiment 29 wherein the instructions further comprise an instruction to change the defined maximum number of PDU sessions for the network slice that can be admitted by the local NSACF (314), and the threshold is a percentage of the changed maximum number of PDU sessions for the network slice that can be admitted by the local NSACF (314).

Embodiment 32: A method performed by a central Network Slice Admission Control Function, NSACF, (800), the method comprising:
receiving (814; 824), from a local NSACF (314), a request to update a number of Protocol Data Unit, PDU, sessions for a network slice;
sending (816; 828) a response to the local NSACF (314), wherein:
   the response indicates that admission of a PDU session to the network slice is either accepted or rejected; and
   the response comprises instructions about handling of future requests to update the number of PDU sessions for the network slice at the local NSACF (314) received in association with PDU session establishment requests for the network slice made by UEs for which the PDU session establishment requests are not associated with a mobility event.

Embodiment 33: The method of embodiment 32 wherein the particular UE is a UE for which the PDU session establishment request is not associated with a mobility event, and the response sent from the central NSACF (800) to the local NSACF (314) indicates that admission of a PDU session for the particular UE to the network slice is rejected.

Embodiment 34: The method of embodiment 32 wherein the particular UE is a UE for which the PDU session establishment request is made in association with a mobility event for the particular UE, and the response sent from the central NSACF (800) to the local NSACF (314) indicates that admission of a PDU session for the particular UE to the network slice is accepted.

Embodiment 35: The method of any of embodiments 32 to 34 wherein the instructions comprise an instruction to not admit PDU sessions for which respective PDU session establishment requests are not associated with a mobility event until the number of PDU sessions for the network slice at the local NSACF (314) is less than a threshold.

Embodiment 36: The method of embodiment 35 wherein the threshold is a percentage of the defined maximum number of PDU sessions for the network slice that can be admitted by the local NSACF (314).

Embodiment 37: The method of embodiment 36 wherein the instructions further comprise an instruction to change the defined maximum number of PDU sessions for the network slice that can be admitted by the local NSACF (314), and the threshold is a percentage of the changed maximum number of PDU sessions for the network slice that can be admitted by the local NSACF (314).

Embodiment 38: A network node adapted to perform the method of any of embodiments 26 to 37.

1-7. (canceled)

8. A method performed by a local Network Slice Admission Control Function, NSACF, the method comprising:
receiving from a network function a first request to update a number of registered User Equipments, UEs, for a network slice in association with a registration request for a particular UE for the network slice;
in response to determining that a maximum number of registered UEs for the network slice is reached, sending a second request to update the number of registered UEs for the network slice to a central NSACF;
receiving a response from the central NSACF, wherein:
the response indicates that admission of the particular UE to the network slice is either accepted or rejected; and
the response comprises an instruction defining a threshold to be applied by the local NSACF for future requests to update the number of registered UEs for the network slice for new UE registrations to the network slice;
rejecting or accepting admission of the particular UE for the particular network slice in accordance with the response received from the central NSACF; and
applying the instruction from the central NSACF when determining whether the local NSACF can admit new UE registrations to the network slice in future requests to update the number of registered UEs for the network slice at the local NSACF.

9. The method of claim 8 wherein the first request or the second request include an indication that the registration request is related to a mobility event of the UE moving from an old service area.

10. The method of claim 8 wherein the particular UE is a UE for which the registration request is a new registration request, and the response from the central NSACF indicates that admission of the particular UE to the network slice is rejected.

11. The method of claim 8 wherein the particular UE is a UE for which the registration request is made in association with a mobility event for the particular UE, and the response from the central NSACF indicates that admission of the particular UE to the network slice is accepted.

12. The method of claim 8 wherein the threshold defined by the instructions is an adjusted maximum number of registered UEs for the network slice that can be admitted by the local NSACF.

13. The method of claim 12 wherein the instruction comprises an instruction to not admit new UE registrations until the number of registered UEs for the network slice at the local NSACF is less than a defined percentage of the threshold.

14. (canceled)

15. (canceled)

16. A method performed by a central Network Slice Admission Control Function, NSACF, the method comprising:
receiving, from a local NSACF, a request to update the number of registered UEs for a network slice;
sending a response to the local NSACF, wherein:
the response indicates that admission of the particular UE to the network slice is either accepted or rejected; and
the response comprises an instruction defining a threshold to be applied by the local NSACF for future requests to update the number of registered UEs for the network slice for new UE registrations to the network slice.

17. The method of claim 16 wherein the request includes an indication that the registration request is related to a mobility event of the UE moving from an old service area.

18. The method of claim 16 further comprising keeping a sufficient reserve of quota for handling admission of UEs moving between service areas.

19. The method of claim 16 wherein the particular UE is a UE for which the registration request is a new registration request, and the response sent from the central NSACF to the local NSACF indicates that admission of the particular UE to the network slice is rejected.

20. The method of claim 16 wherein the particular UE is a UE for which the registration request is made in association with a mobility event for the particular UE, and the response sent from the central NSACF to the local NSACF indicates that admission of the particular UE to the network slice is accepted.

21. The method of claim 16 wherein the threshold defined by the instructions is an adjusted maximum number of registered UEs for the network slice that can be admitted by the local NSACF.

22. The method of claim 21 wherein the instruction comprises an instruction to not admit new UE registrations until the number of registered UEs for the network slice at the local NSACF is less than a defined percentage of the threshold.

23. (canceled)

24. A network node for implementing a central Network Slice Admission Control Function, NSACF, the network node comprising processing circuitry configured to cause the network node to:
receive, from a local NSACF, a request to update the number of registered UEs for a network slice;
send a response to the local NSACF, wherein:
the response indicates that admission of the particular UE to the network slice is either accepted or rejected; and
the response comprises an instruction defining a threshold to be applied by the local NSACF for future requests to update the number of registered UEs for the network slice for new UE registrations to the network slice.

25-48. (canceled)
